(19) United States
(12) Patent Application Publication
(10) Pub. No.: US 2012/0232797 A1
(43) Pub. Date: Sep. 13, 2012

(54) METHOD AND APPARATUS FOR DETECTING AND MAPPING SUBSURFACE RESISTIVITY ANOMALIES

(76) Inventors: Michael Frenkel, Houston, TX (US); Sofia Davydycheva, Houston, TX (US)

(21) Appl. No.: 13/415,348

(22) Filed: Mar. 8, 2012

Related U.S. Application Data
(60) Provisional application No. 61/450,598, filed on Mar. 8, 2011.

(51) Int. Cl. G06F 19/00; G01V 3/12; G06F 17/18; G01V 9/00

(52) U.S. Cl. 702/2; 702/179; 702/6; 702/13

(57) ABSTRACT

A method for detecting a subterranean anomaly is provided. The method includes receiving signal data derived from a plurality of transmitters and at least one receiver; calculating a relationship for selected combinations of measurements provided by the signal data; estimating weighting factors for each transmitter, for a condition where there is a substantially equivalent potential across each of the transmitters; applying the weighting factors to the data; and identifying the anomaly in weighted data. Apparatus are also provided.

### CROSS REFERENCE TO RELATED INVENTIONS

This patent application is filed under 35 U.S.C. §111(a), and claims priority under 35 U.S.C. §119(e) to U.S. Patent Application No. 61/450,598, filed Mar. 8, 2011, the entire disclosure of which is incorporated by reference herein in its entirety.

### BACKGROUND OF THE INVENTION

1. Field of the Invention

The present invention relates to characterizing subterranean conditions and formations, and in particular to three-dimensional assessment of subsurface anomalies such as tunnels, cavities, faults, natural resources as well as soil properties.

2. Description of the Related Art

Unknown subsurface cavities located in highly-populated urban areas, below buildings, power stations, pathways, roads, or other places with human activities can lead to dangerous accidents. Detection of such subsurface cavities and assessment of their parameters (depth, size, and propagation path) are needed to perform operations preventing possible collapses and improve human and environmental safety.

Underground cross-border tunnels have proven to be a growing problem for national security in many parts of the world. The majority of cross-border clandestine tunnels have been found without the use of technology.

Some technology is available in the quest to identify underground anomalies such as cavities and tunnels. Ground-Penetrating Radar (GPR) is currently a leading Electromagnetic (EM) method used to spot tunnels. However, reliable detection of small and deep air-filled tunnels can be a challenging problem for the GPR-based technology.

For example, a depth-of-penetration (DOP) of the EM signal generated by GPR is determined primarily by the background/overburden resistivity (R_{bg}) and frequency. Resolution and DOP of GPR dramatically changes with small variations in water content and resistivity of the overburden layer. More specifically, the GPR signal has low DOP in moist relatively low-resistive media like clay. False alarms are typical even at shallow depths.

What are needed are methods and apparatus for providing reliable detection and assessment of tunnels, cavities and other subsurface resistivity anomalies such as accumulations of hydrocarbons and other natural resources. Preferably, the techniques provide for reliable detection under a variety of conditions, and when encountering a variety of other subterranean features.

### BRIEF SUMMARY OF THE INVENTION

In one embodiment, disclosed herein is a method for detecting a subterranean anomaly, the method comprising: receiving signal data derived from a plurality of transmitters and at least one receiver; calculating a relationship for selected combinations of measurements provided by the signal data; estimating weighting factors for each transmitter, for a condition where there is a substantially equivalent potential across each of the transmitters; applying the weighting factors to the data; and identifying the anomaly in weighted data.

In another embodiment, disclosed herein is a detection system, comprising: a plurality of transmitters and at least one receiver coupled to a controller, the controller configured for implementing machine executable instructions stored on machine readable media, the instructions for receiving signal data derived from a plurality of transmitters and at least one receiver; calculating a relationship for selected combinations of measurements provided by the signal data; estimating weighting factors for each transmitter, for a condition where there is a substantially equivalent potential across each of the transmitters; applying the weighting factors to the data; and identifying the anomaly in weighted data.

In a further embodiment, disclosed herein is an apparatus for detecting subterranean anomalies, the apparatus comprising: a detection system comprising a plurality of transmitters and at least one receiver coupled to a controller, the controller configured for implementing machine executable instructions stored on machine readable media, the instructions for: receiving signal data derived from a plurality of transmitters and at least one receiver; calculating a relationship for selected combinations of measurements provided by the signal data; estimating weighting factors for each transmitter, for a condition where there is a substantially equivalent potential across each of the transmitters; applying the weighting factors to the data; and identifying the anomaly in weighted data.

### BRIEF DESCRIPTION OF THE DRAWINGS

The invention will be more fully understood by reference to the detailed description, in conjunction with the following figures, wherein:

FIG. 1 is a cut-away side view depicting aspects of a detection system for detection of a tunnel or any other subsurface anomaly;

FIG. 2 is a top-down view of placement of transmitters and a receiver for the embodiment of the detection system depicted in FIG. 1;

FIG. 3 is a line diagram depicting aspects of system setup in relation to the layout of the detection system;

FIG. 4 is a line diagram depicting aspects of system setup for another embodiment of the detection system;

FIG. 5 depicts a configuration of the detection system that was used for validation of the teachings herein;

FIG. 6 is a graph depicting modeling results for the methods disclosed herein;

FIGS. 7A-7F, collectively referred to herein as FIG. 7, depict ground penetrating radar performance for the scenario used in FIG. 6;

FIGS. 8A-8F, collectively referred to herein as FIG. 8, depict ground penetrating radar performance for the scenario used in FIG. 6;

FIGS. 9A-9C, collectively referred to herein as FIG. 9, depict modeling results for a deeper tunnel using the methods disclosed herein;

FIG. 10 depicts modeling results for a deeper tunnel using the methods disclosed herein;

FIGS. 11A-11C, collectively referred to herein as FIG. 11, depict modeling results for a deeper tunnel using the methods disclosed herein; and

FIGS. 12 and 13 depict aspects of a mobile detection system.

### DETAILED DESCRIPTION OF THE INVENTION

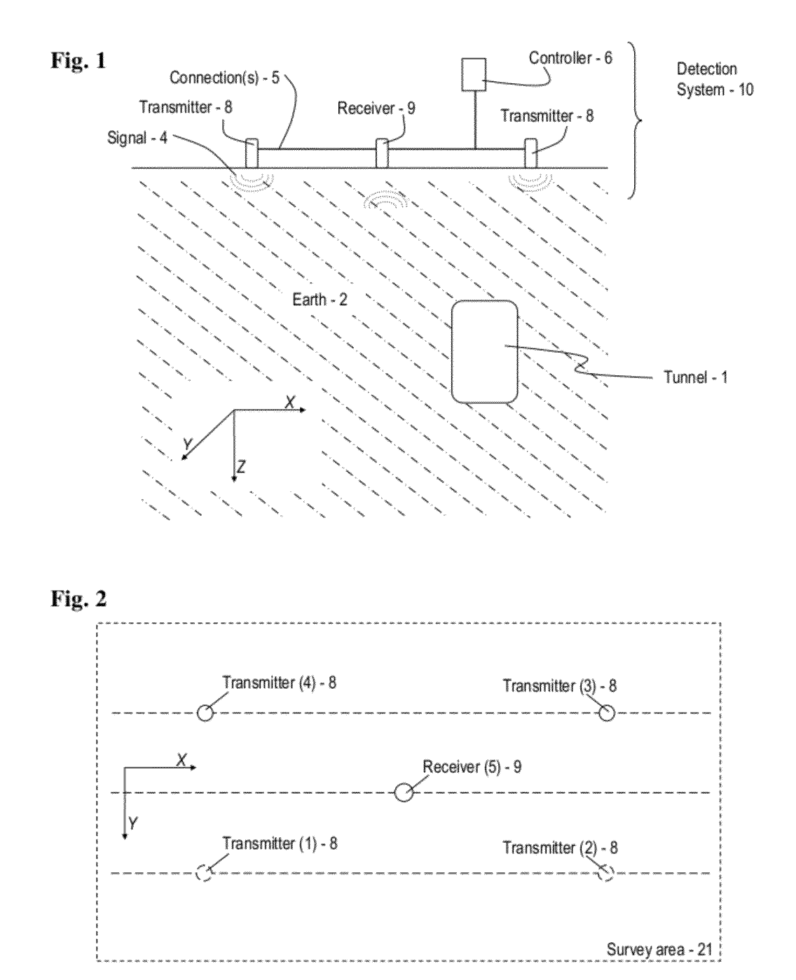

Disclosed herein are methods and apparatus for detecting subsurface anomalies. In general, the techniques provided are directed to detection of tunnels and the like. However, the techniques are useful in the detection of other subsurface conditions, such as the presence of hydrocarbons. In order to provide some context, reference may be had to FIG. 1, where an embodiment of a detection system is shown.

Referring now to FIG. 1, there is shown a tunnel 1. The tunnel 1 traverses a section of Earth 2. An embodiment of a detection system 10 is shown and provides for detection of the tunnel 1. In this example, the detection system 10 include a plurality of transmitters 8, in this case, each transmitter 8 is a horizontal electric dipole (HED) transmitter. The detection system 10 further includes at least one receiver 9. In this example, the receiver 9 includes a five electrode quadrupole receiver.

Each of the transmitters 8 and the at least one receiver 9 is in electrical communication with a controller 6 by a respective connection 5. Generally, the controller 6 includes apparatus as appropriate for processing data from the at least one receiver 9 and controlling generation of at least one signal 4 by the transmitters 8.

Generally, the transmitters 8 transmit the signal 4 into the Earth 2, and the at least one receiver 9 receives a return signal 4. The signal 4 may be within a time range of, for example, 8-32 micro-seconds for shallow targets and between about 30 to 250 milliseconds for deep hydrocarbon targets, while also varying current, I and the like. Generally, the detection system 10 uses electric dipole-dipole and dipole-quadrupole measurements for detection and assessment of subsurface anomalies as well as for determination of soil properties.

A physical appearance of the transmitters 8 and the receiver 9 may be as similar (or identical) electrodes. As a matter of convention, as used herein, the transmitters 8 transmit the electrical signal 4, while the receiver 9 receives the electrical signal 4. It should be recognized that any one or more of the electrodes may be reconfigured with minimal effort to modify the detection system 10. For example, any one or more of the electrodes may be reconfigured within the controller 6 to provide for fulfillment of an opposing function (e.g., a transmitter 8 is switched to a receiver 9, or vice-versa).

More specifically, the controller 6 may include (and/or be coupled to as appropriate), for example, at least one processor, memory, data storage, machine executable instructions stored on machine readable media (i.e., software), a power source, a receiver, a transmitter, a switch, a transformer, a converter, at least one communications channel, a sub-system for providing a user-interface (UI) and various other components as are known in the art in support of making electromagnetic measurements, providing computer controls, or as appropriate for otherwise enabling the controller 6 to perform tasks or exhibit functionality as provided herein.

As shown in FIG. 1, and only for purposes of convention and the description herein, the detection system 10 may be disposed on a surface (i.e., in a plane defined by an X-axis and a Y-axis, referred to as an “X-Y plane”). Also for purposes of convention and the description herein, a depth into the Earth 2 is measured along a Z-axis.

Referring now to FIG. 2, a survey area 21 is generally defined by a placement of the plurality of transmitters 8 and the at least one receiver 9. As a matter of convenience, and for referencing herein, each of the plurality of transmitters 8 and the at least one receiver 9 are labeled numerically ((1), (2), (3), (4), (5)). Such notation is merely for explanation and is not intended to denote an order of arrangement or otherwise be limiting of the teachings herein.

Aspects of system setup are shown within the survey area 21. In this example, the detection system 10 includes four grounded Horizontal Electric Dipole (HED) transmitters 8 ((1), (2), (3), (4)) and a five-electrode quadrupole receiver. If the potential of the electric field is denoted as U, then a measurement of voltage taken at the receiver 9 measures may be calculated according to Eq. (1):

V=d²U=(U₁−2U₅+U₃+U₂−2U₅+U₄)/4 (1);

which represents a sum of two second differences of the electric potential between electrodes 1, 5, 3, and 2, 5, 4, respectively, divided by four (or, a circular second difference of the electric potential). Thus, as depicted, the receiver 9 is in effect a combination of two quadrupoles having negative (internal) co-located poles. Horizontal components of the electric field, or the first differences of the electric potential U₁-U₃, and U₂-U₄, are also measured using a standard dipole measurement (accordingly, receiving HEDs may also be embedded in the receiver 9; but, are not shown in FIG. 1).

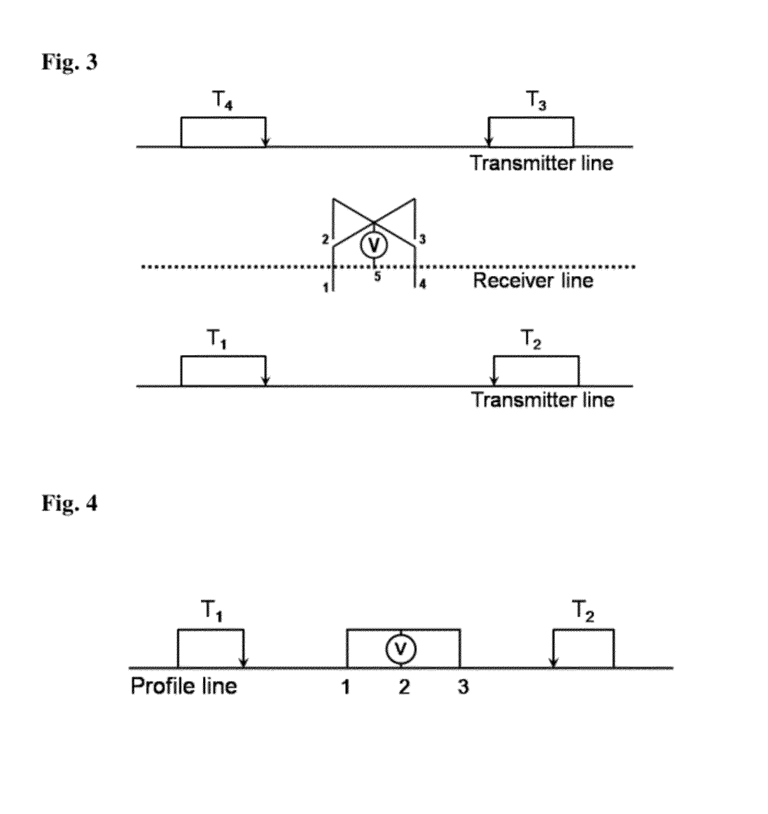

In the setup shown in FIG. 3, the four horizontal electric dipole transmitters 8 and a five-electrode grounded quadrupole receiver 9 are oriented in the X-Y plane. The x-coordinates and the y-coordinates of the receiver 9 are (xᵣ, yᵣ)=(0, 0); the coordinates of the transmitters 8 are (x₁, y₁); (−x₁, y₁); (−x₁, −y₁), and (−x₁, y₁). This setup provides, among other things, complete elimination of axial horizontal current at the grounded electric quadrupole receiver 9.

Each transmitter 8 excites the Earth 2 (also referred to as a “geological formation” and by other similar terms) by repeating low-frequency square pulses of an electromagnetic field. When current, I, is on, the geometrical DC sounding is performed in a wide range of the setup offsets, which provides preliminary data on the resistivity of the geological formation. This may reflect the presence of hydrocarbon-bearing rocks, which are often more resistive than surrounding rocks, or another anomaly. The transient response of the geological formation is measured between the pulses (in what may be referred to as an “off-time”). The signal 4 may include square pulses of alternating polarity to remove static, industrial, magnetotelluric, and other types of noise.

Taking a particular linear combination of these four measurements at the receiver 9 provides a complete vertical focusing of the electric current, I, and elimination of the influence of both x-directed and y-directed axial currents at the receiver 9. Weighting factors are obtained from the condition of equal potentials in the electrodes 1, 2, 3 and 4, if all transmitters 8 would be excited simultaneously. This solution is equivalent to creating an equal-potential surface around the electrodes 1, 2, 3 and 4 by means of an automatic feedback loop.

In a homogeneous half-space or in a horizontally-layered one-dimensional medium, this technique results in equal weights of all four measurements. That is, the response from a single transmitter 8 in a one-dimensional medium would be equivalent to response from each combination of the transmitters 8 with the receiver 9. In an arbitrary three-dimensional media, all four resulting weighting factors (or “coefficients”) may differ somewhat, for example, as a result of the distorting effects of various shallow lateral heterogeneities. This makes the method significantly less sensitive to unwanted lateral effects while remaining sensitive to a relatively narrow column of rocks situated directly below the receiver.

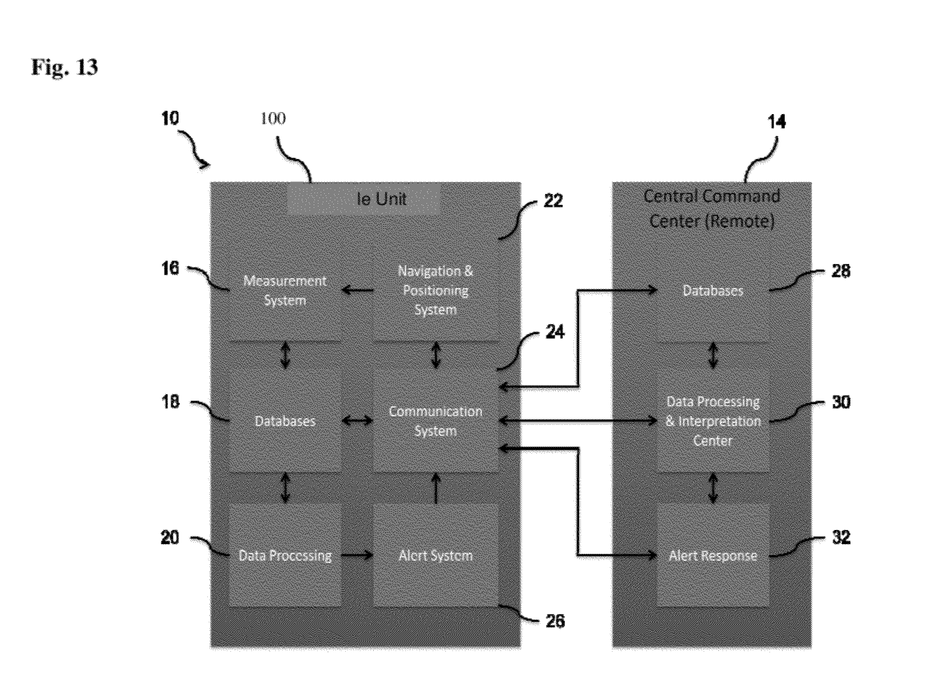

In practice, the detection system 10 of the four transmitters 8 and one receiver 9 may be deployed as a mobile unit, such as by being deployed in a motor vehicle and moving along a predetermined path (profile), over a grid (number of profiles), above a possible tunnel or other possible subsurface anomaly location. The mobile unit (not shown) may configured in a variety of ways (for example, the mobile unit may be manned or un-manned). This is discussed in greater detail with regards to FIGS. 12 and 13.

In practice, the transient electromagnetic (EM) data is recorded at a given sampling rate. Interpretation and comparison to a baseline (i.e., background data) is done in real time (e.g., at a rate that is adequate to satisfy the tolerance of acceptability defined by a user). Anomalous sites that are potential tunnels or other anomalies can be immediately identified, and follow up actions may be immediately initiated.

Generally, the receiving and transmitting electrodes are grounded. However, perfect grounding is not necessary. More specifically, analysis has shown that for implementations having imperfect equal grounding, the impedance of each electrode may result in different weights of the four measurements, but the final result, after applying the automatic focusing post-processing, is practically undisturbed.

Refer now to FIGS. 3 and 4 for more detail. When using a simplified axial (a two-dimensional, or linear) setup as shown in FIG. 4, two ratios of dipole and quadrupole measurements from each transmitter 8 are analyzed (i.e., ratios of the first and the second differences of the electric potential, U). Taking a particular linear combination of these two measurements at the receiver 9 provides vertical focusing of the electric current and elimination of influence of x-directed axial current at the receiver 9. Refer to Equation (2):

$${R}_{x} = {[ {\sum }_{i = 1}^{2} {w}_{i} \frac{{U}_{1}^{i} - 2 {U}_{2}^{i} + {U}_{3}^{i}}{{U}_{1}^{1} - {U}_{3}^{1}} ]}^{- 1} , \qquad ( 2 )$$

where Uⱼⁱ is the electric potential in j-th electrode of the receiver excited by i-th transmitter, the weight w₁=1, and the weight w₂ is adjusted from the condition of equal potentials in the electrodes 1 and 3, when the both transmitters are excited (as described by Equation (3)):

U₁¹−U₃¹+w₂(U₁−U₃²)=0 (3)

By neglecting y-directed current on the setup axis, the effect of the horizontal x-directed current is fully cancelled and the effect of the vertical current is duplicated. Therefore, this provides for reducing sensitivity to the lateral variations of the resistivity in the near-surface layer and increasing the sensitivity to deeper structures situated below the receiver 9.

Y-directed current is accounted for when using an advanced three-dimensional setup shown in FIG. 3 (i.e., a rectangular array of four transmitters 8). Thus, the four ratios of dipole and quadrupole measurements for each transmitter 8 may be derived.

Taking a linear combination of these four measurements at the receiver 9 provides for vertical focusing of the electric current and elimination of the influence of both x-directed and y-directed axial current at the receiver 9. That is, the influence of current in the horizontal direction (or X-Y plane, and therefore may be referred to as “planar current” or “horizontal current” herein) is substantially reduced. Refer to Equation (4):

$${R}_{xy} = {[ {\sum }_{i = 1}^{4} {w}_{i} ( \frac{{U}_{1}^{i} + {U}_{2}^{i} + {U}_{3}^{i} + {U}_{4}^{i} - 4 {U}_{5}^{i}}{{U}_{1}^{1} - {U}_{3}^{1}} ) ]}^{- 1} , ; \qquad ( 4 )$$

where w₁=1, and the weights w₂, w₃ and w₄ are obtained from the condition of equal potentials in the electrodes 1, 2, 3, and 4, which is observed when all of the transmitters 8 are excited. Thus, to obtain the weighting factors for each measurement, the linear system of Equation (5) is solved with respect to the weights w₂, w₃, and w₄:

U₁¹−U₂¹+w₂(U₁²−U₂²)+w₃(U₁³−U₂³)+w₄(U₁⁴−U₂⁴)=0,

U₁¹−U₄¹+w₂(U₁²−U₄²)+w₃(U₁³−U₄³)+w₄(U₁⁴−U₄⁴)=0,

U₁¹−U₃¹+w₂(U₁²−U₃²)+w₃(U₁³−U₃³)+w₄(U₁⁴−U₃⁴)=0. (5).

This solution is equivalent to creating an equal-potential surface around the electrodes 1, 2, 3 and 4 by use of the automatic feedback loop. One may prove that it does not matter what to put in the denominator (4), U₁¹−U₃¹ or U₂¹−U₄¹. That is, the results are identical and so the denominator (4) is generally inconsequential.

In homogeneous space or in a horizontally-layered one-dimensional medium, this technique results in equal weights of all four measurements. That is, the response from a single transmitter 8 in the one-dimensional medium is identical to the response from the combination of the transmitters 8 shown in FIGS. 3 and 4. In an arbitrary three-dimensional media, all four resulting coefficients or weighting factors wᵢ may differ, for example, as a result of distorting effects of various shallow lateral heterogeneities. This makes the method insensitive to unwanted lateral effects and sensitive to a relatively narrow anomaly situated directly below the receiver 9.

The techniques disclosed herein were validated by modeling of the methods, and comparison to the prior art techniques using ground penetrating radar (GPR). Reference may be had to FIG. 5.

A wide scope of three-dimensional modeling tests was performed. The models were for a 2 m×2 m (cross-section size) long (two-dimensional) tunnel located at several depths below the surface ranging from 3 m to 16 m. The background resistivity ρ_{bg} was set to two relatively low-resistivity values of 2 Ωm and 20 Ωm. The three-dimensional time-domain forward modeling problem with respect to the EM field excited by a grounded electric dipole was discretized on a finite-difference (FD) grid and solved iteratively.

The GPR method was tested for the shallow targets located at 3 and 5 m below the surface and for the same values of ρ_{bg}=2 and 20 Ωm. In the GPR case, the three-dimensional frequency-domain forward problem for an array of two vertical magnetic dipoles is solved by a similar finite-difference scheme.

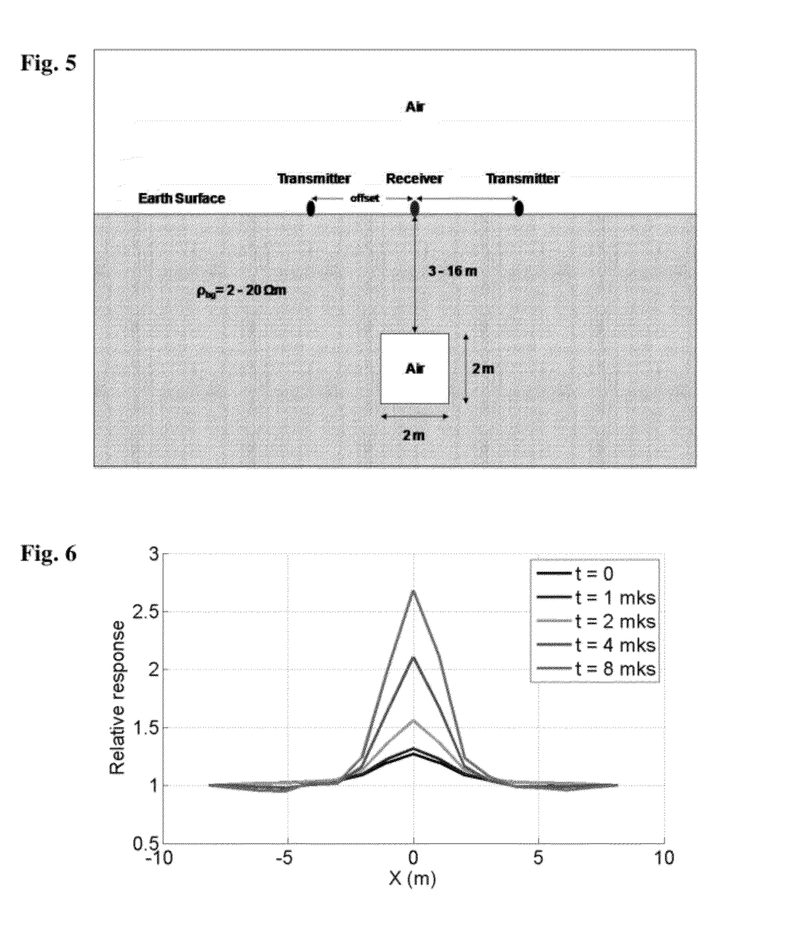

Refer to FIG. 6, which show results for the disclosed methods. In FIG. 6, normalized values of the electromagnetic (EM) signal (y-axis) measured at the receiver locations are presented. Normalization was done using the background EM signal recorded above the homogeneous half-space model without a tunnel. In this example, the survey conditions were 3 m deep, ρ_{bg}=2 Ωm: EM anomaly is >150% for times t>3 mks.

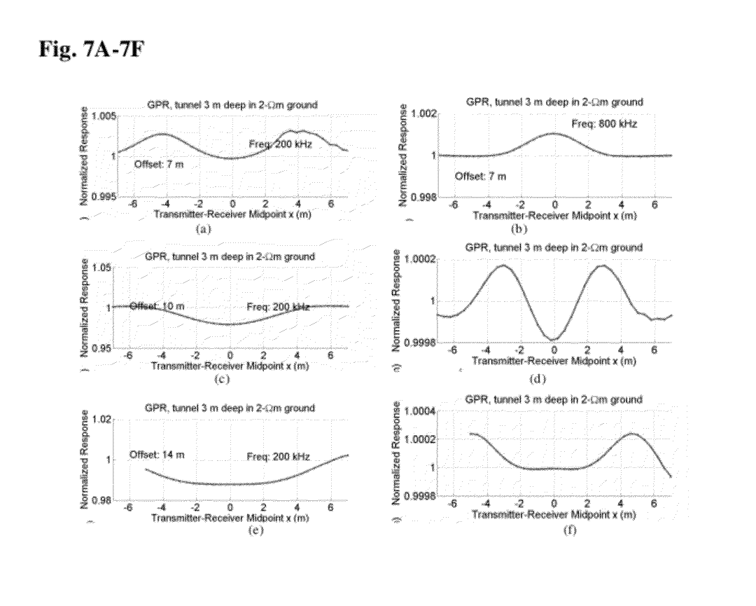

Refer now to FIG. 7 for comparative performance of the ground-penetrating radar (GPR). In this simulation, τ_{bg}=2 Ωm, and (FIG. 7A) and (FIG. 7B)—offset 7 m, f=200 and 800 kHz; (FIG. 7C) and (FIG. 7D)—offset 10 m, f=200 and 800 kHz; (FIG. 7E) and (FIG. 7F)—offset 14 m, f=200 and 800 kHz. In all the cases, the GPR anomaly is <2%.

In FIG. 6, simulation of performance of the detection system 10 is provided for a relatively shallow tunnel located 3 m below the Earth's surface (for ρ_{bg}=2 Ωm). In this case, the EM anomaly is strong, higher than 150% for times t>3 mks and exceeds 200% at t>4 mks. As may be interpreted from FIG. 6, detecting this kind of shallow anomaly would be an easy task for the methods disclosed.

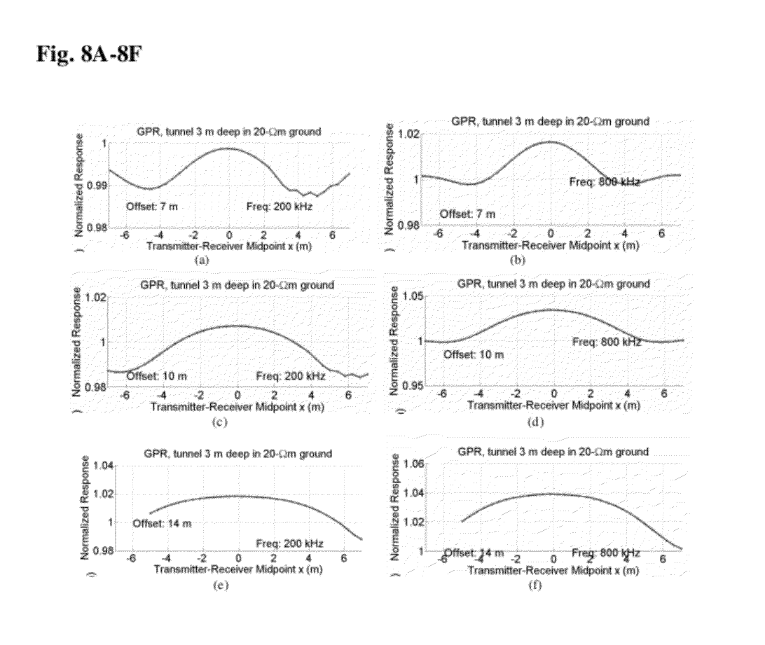

The data provided in FIG. 7 shows performance to be substantially poor in comparison. FIGS. 7A-7F show the normalized vertical magnetic (H_{z}) component for 200 and 800 kHz and for the transmitter-receiver offsets of 7, 10, and 14 m. In all the cases, the GPR anomaly is below 2%, which is insufficient to reliably identify a potential tunnel. FIG. 8 depicts GPR results where resistivity has been substantially increased.

FIG. 8 presents GPR simulation results for the same shallow tunnel of FIGS. 6-7, but the background resistivity is increased to ρ_{bg}=20 Ωm. As in FIG. 7, the normalized magnetic H_{z} component for 200 and 800 kHz and for the transmitter-receiver offsets of 7, 10, and 14 m is displayed. In all the cases, the GPR anomaly is below 4%. The results of modeling presented in FIGS. 7 and 8 indicate that even in the case of a shallow tunnel located 3 m below the surface and the background resistivity ρ_{bg}≦20 Ωm, a modeled GPR system does not have enough sensitivity to detect 2×2 m air-filled tunnels.

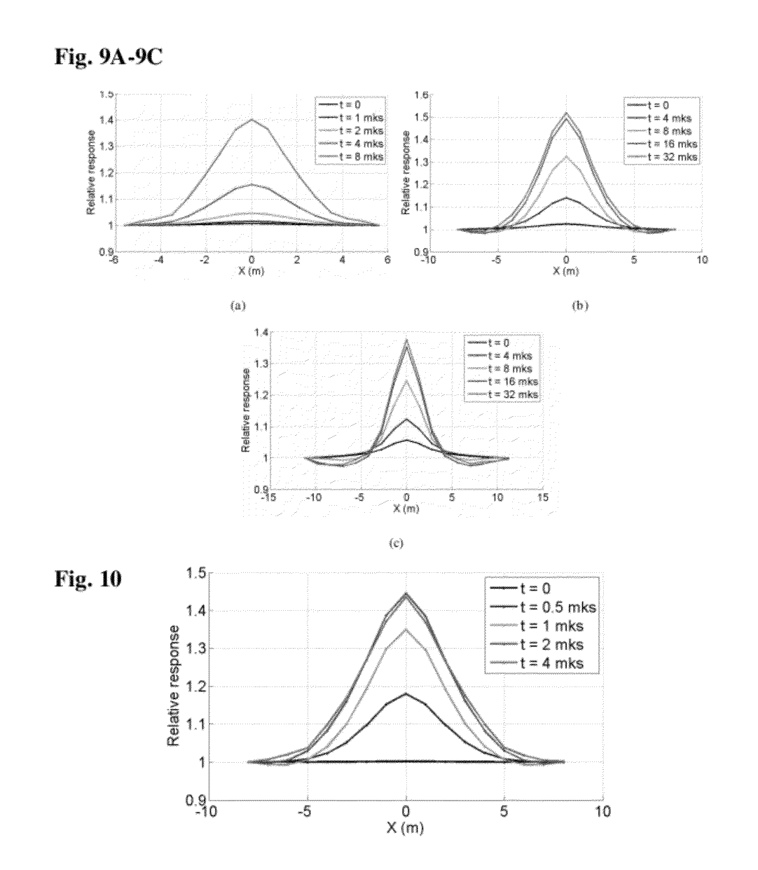

Accordingly, further tests of the method were restricted to these two background resistivity cases (ρ_{bg}=2 and 20 Ωm) and responses from deeper tunnels located from 5 to 16 m below the surface were evaluated (see FIGS. 9-11).

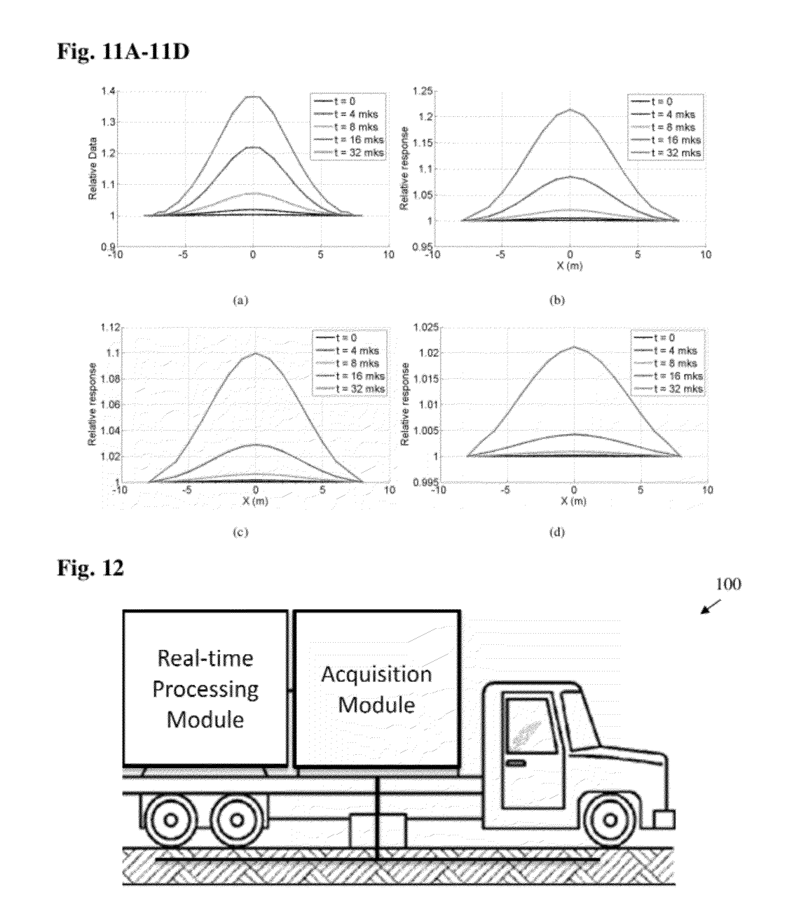

In FIG. 9, simulation results are presented for a tunnel that is 2×2 m, 5 m deep, ρ_{bg}=2 Ωm, offsets (FIG. 9A) 3.5, (FIG. 9B) 5, and (FIG. 9C) 7 m: EM anomaly is up to 50%. In FIG. 10, simulation results are presented for a tunnel that is 2×2 m, 5 m deep, ρ_{bg}=20 Ωm, offset 5 m: EM anomaly is >40%. In FIG. 11, simulation results are presented for a tunnel that is 2×2 m, (FIG. 11A) 8 m, (FIG. 11B) 10 m, (FIG. 11C) 12 m, and (FIG. 11D) 16 m deep; ρ_{bg}=2 Ωm, offset=5 m: EM anomaly levels are 38, 21, 10, and 2%, respectively.

As a further proof of concept, modeling was performed for a 2 m×2 m tunnel that was 8 meters deep, with a small obstruction 1 meter deep. In this model, the R_{bg} was set to 2.0 Ωm and the obstruction resistivity, Rₒ, was set in the first test to Rₒ=0.02 Ωm and in the second test to Rₒ=100 Ωm. In summary, the modeling tests showed that GPR was relatively insensitive to the tunnel, however, exhibited sensitivity to the shallow obstruction. In contrast, the detection system 10 was sensitive to both structures. Making use of time-differentiation modeling in this example, permitted the shallow obstruction to be fully resolved and removed from the data.

Simulation results for a 2×2 m air-filled tunnel are summarized in Table 1. The levels of anomalous signals for all the simulated cases, except, perhaps, for the case when the tunnel is located at 16 m depth, are sufficient for detecting and fast inversion imaging. A simulated GPR system has been shown to be ineffective for detecting these tunnels embedded in media of background resistivity ρ_{bg}≦20 Ωm.

TABLE 1
Comparative Data

| Tunnel Depth | Detection System | | Ground Penetrating Radar | |
|---|---|---|---|---|
| (m) | ρ_{bg} = 2 Ωm | ρ_{bg} = 20 Ωm | ρ_{bg} = 2 Ωm | ρ_{bg} = 20 Ωm |
| 3 | >150% | >100% | <1% | <4% |
| 5 | 50% | >40% | N/A | <3% |
| 8 | 30% | >25% | N/A | N/A |
| 10 | 20% | >15% | N/A | N/A |
| 12 | 10% | 5% | N/A | N/A |
| 16 | 2% | N/A | N/A | N/A |

In summary, a new method for detecting and imaging small underground tunnels is disclosed. In various embodiments, the Tunnel Detection Focused-Source EM (TD-FSEM) technology uses four horizontal electric dipole transmitters and a five-electrode grounded quadrupole receiver unit to measure the transient EM field. Such a setup directs the exciting current under the receiver vertically downward, increasing the sensitivity to a relatively narrow column of rocks directly below the receiver.

Referring now to FIGS. 12 and 13, an embodiment of the detection system 10 is shown deployed on a mobile unit 100. In this example, the detection system 10 include a measurement system 16 (that, in turn, includes a plurality of transmitters 8 and at least one receiver 9, and other components as appropriate), a data processing unit 20, an alert system 26, a database 18, a communication system 24 and a navigation system 22. The detection system 10 may be in communication with a remote center 14, which, in turn, may include appropriate components such as a remote database 28, a remote data processing center 30 and a remote alert system 32.

The mobile unit 100 may be operated in a manned or unmanned fashion. During operation, the mobile unit 100 will generally progress to a survey point, ground the electrodes (i.e., the plurality of transmitters 8 and the receiver 9), turn on a source to commence transmission of the signal 4, collect data, and then withdraw. The measurement process (data collection) may involve varying the signal in the time domain, as well as the frequency domain, as appropriate. Multiple measurements at the same point or a number of points during a survey can also be performed to improve a signal-to-noise ratio (SNR).

When using the detection system 10 along a routine route, for example, additional benefits may be realized. For example, specific survey points may be routinely surveyed, thus providing users with data that is statistically more reliable. Accordingly, the database 18 may include historic data to provide enhanced information to a user based, for example, on time-lapse (4D) data analysis.

Such techniques are not limited to tunnel detection, but may be useful in a variety of other settings. For example, when characterizing soil properties, the effect of weathering and other such variables may be better understood.

Numerical tests have shown that the method disclosed provides data sufficient for reliable real-time detection of deep tunnels embedded in relatively low-resistivity environments (ρ_{bg}≦20 Ωm), which has not been achievable using prior art ground penetrating radar. Advantageously, the disclosed method provides for, among other things, deep depth of investigation and high spatial resolution, a high signal-to-noise ratio, automatic removal of unwanted shallow effects, real-time visual interpretation, and applicability of a fast one-dimensional inversion-based subsurface imaging.

The technology may be used in a variety of settings. For example, users are now provided with technology for border security, such as for detection and mapping of subsurface clandestine tunnels/ways; in agriculture, such as for evaluation of soil properties; in environmental studies, such as for assessment of waste sites, hydrocarbon spills, new construction sides in civil engineering, such as for construction and monitoring of power stations (including nuclear), roads, tunnels, waterways, buildings, underground storage, pipelines; in the mining industry, such as for exploration for ore and other mineral deposits; in the petroleum industry, such as for exploration and monitoring of onshore hydrocarbon fields (in the presence of arbitrary terrain environments); and in just about any situation where assessment of subsurface resistivity anomalies or cavities or other objects/targets is desired.

In the foregoing implementations, and others not listed herein, the detection system 10 may be configured for a particular task. For example, measurement routines and components (i.e., signal strength, measurement duration, pulse length, frequency, a number of transmitters and/or receivers, and the like) may be varied or configured for a particular need.

It should be recognized that relative terms such as “substantially,” “reduce” and the like do not imply any particular limitations.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A method for detecting a subterranean anomaly, the method comprising:
receiving signal data derived from a plurality of transmitters and at least one receiver;
calculating a relationship for selected combinations of measurements provided by the signal data;
estimating weighting factors for each transmitter, for a condition where there is a substantially equivalent potential across each of the transmitters;
applying the weighting factors to the data; and
identifying the anomaly in weighted data.

2. The method of claim 1, further comprising transmitting an electric signal from at least one of the transmitters.

3. The method of claim 2, wherein the transmitting comprises transmitting pulses of a low-frequency electromagnetic field.

4. The method of claim 1, wherein plurality of transmitters comprises a rectangular array of four transmitters and the at least one receiver comprises a five-electrode quadrupole receiver.

5. The method of claim 1, wherein the calculating comprises determining a ratio of at least one dipole measurement and at least one quadrupole measurement for each of the selected combinations.

6. The method of claim 1, wherein the applying substantially reduces an influence of horizontal current and substantially provides for focusing of current from the transmitters in a vertical direction.

7. The method of claim 1, wherein the identifying is performed by at least one of data processing, modeling and inversion.

8. A detection system, comprising:
a plurality of transmitters and at least one receiver coupled to a controller, the controller configured for implementing machine executable instructions stored on machine readable media, the instructions for
receiving signal data derived from a plurality of transmitters and at least one receiver;
calculating a relationship for selected combinations of measurements provided by the signal data;
estimating weighting factors for each transmitter, for a condition where there is a substantially equivalent potential across each of the transmitters;
applying the weighting factors to the data; and
identifying the anomaly in weighted data.

9. The system of claim 8, wherein the calculating comprises solving a relationship comprising:
$${R}_{x} = {[ {\sum }_{i = 1}^{2} {w}_{i} \frac{{U}_{1}^{i} - 2 {U}_{2}^{i} + {U}_{3}^{i}}{{U}_{1}^{1} - {U}_{3}^{1}} ]}^{- 1} ;$$
where Uⱼⁱ represents electric potential in j-th electrode of the receiver excited by i-th transmitter;
weighting factor w₁=1; and
weighting factor w₂ is obtained from a condition of substantially equal potential in a first and a third electrode.

10. The system of claim 9, wherein w₂ is calculated from the relationship:
U₁¹−U₃¹+w₂(U₁²−U₃²)=0.

11. The system of claim 8, wherein the calculating comprises solving a relationship comprising:
$${R}_{xy} = {[ {\sum }_{i = 1}^{4} {w}_{i} ( \frac{{U}_{1}^{i} + {U}_{2}^{i} + {U}_{3}^{i} + {U}_{4}^{i} - 4 {U}_{5}^{i}}{{U}_{1}^{1} - {U}_{3}^{1}} ) ]}^{- 1} ;$$
where Uⱼⁱ represents electric potential in j-th electrode of the receiver excited by i-th transmitter;
weighting factors w₁=1; and
weighting factors w₂, w₃ and w₄ are obtained from a condition of substantially equal potential in a first, a second, a third and a fourth electrode.

12. The system of claim 11, wherein weighting factors w₂, w₃, and w₄, are calculated from the relationship:
U₁¹−U₂¹+w₂(U₁²−U₂²)+w₃(U₁³−U₂³)+w₄(U₁⁴−U₂⁴)=0,
U₁¹−U₄¹+w₂(U₁²−U₄²)+w₃(U₁³−U₄³)+w₄(U₁⁴−U₄⁴)=0,
U₁¹−U₃¹+w₂(U₁²−U₃²)+w₃(U₁³−U₃³)+w₄(U₁⁴−U₃⁴)=0. (5).

13. The system of claim 8, wherein identifying is performed substantially in real-time.

14. An apparatus for detecting subterranean anomalies, the apparatus comprising:
a detection system comprising a plurality of transmitters and at least one receiver coupled to a controller, the controller configured for implementing machine executable instructions stored on machine readable media, the instructions for:
receiving signal data derived from a plurality of transmitters and at least one receiver;
calculating a relationship for selected combinations of measurements provided by the signal data;
estimating weighting factors for each transmitter, for a condition where there is a substantially equivalent potential across each of the transmitters;
applying the weighting factors to the data; and
identifying the anomaly in weighted data.

15. The apparatus of claim 14, further comprising a mobile platform upon which the detection system is mounted.

16. The apparatus of claim 14, configured for detecting at least one of a tunnel, a soil property, a water source, hydrocarbons, deposits of ore, deposits of minerals, earth properties useful in civil engineering analyses, environmental waste.
